(19) United States
(12) Patent Application Publication
(10) Pub. No.: US 2008/0100573 A1
(43) Pub. Date: May 1, 2008

(54) COMPACT ERGONOMIC COMPUTER MOUSE

(76) Inventor: JACK LO, PACIFICA, CA (US)

Correspondence Address: JACK LO, 617 VIEWRIDGE DRIVE, PACIFICA, CA, 94044, US

(21) Appl. No.: 11/553,991

(22) Filed: Oct. 27, 2006

(51) Int. Cl. G09G 5/08

(52) U.S. Cl. 345/163

(57) ABSTRACT

A compact ergonomic mouse comprises a thumb side with a thumb engaging portion, a finger side with a finger engaging portion, a top with a button, a bottom, a front, and a rear. The distance between a distal end of the button and a rear of the thumb engaging portion is about 45-55 mm, which is just long enough to enable a last phalanx of the thumb of a relaxed hand to be generally centered on a rear half of the thumb side when a tip of a first finger is on the button and generally even with the distal end of the button, wherein the first finger is substantially curled with a distal phalanx thereof at an angle of about 80-100 degrees from a proximal phalanx thereof, so as to encourage relaxation of the hand.

### BACKGROUND OF THE INVENTION

1. Field of the Invention

The invention broadly relates to compact computer mouses.

2. Prior Art

Computer mouses include full size models for use with desktop computers, and compact models for use with notebook or portable computers. When the fingers are holding a compact mouse, they tend to at different angles and positions than when they are holding a full size mouse. However, mouse designers do not seem to understand this. Therefore, typical compact mouses are simply proportionately scaled down versions of the full size models.

For example, a typical full size mouse is the “INTELLIMOUSE EXPLORER” by Microsoft Corp. It is about 5 inches (127 mm) long and about 3.2 inches (81 mm) wide, so the aspect ratio is 1.57:1. A typical compact mouse is the “POCKETMOUSE” by Kensington Computer Products Group. It is about 3.5 inches (89 mm) long and about 2 inches (50 mm) wide, so the aspect ratio is 1.78:1. The smallest prior art optical mouse is the “HP ULTRA MINI OPTICAL MOUSE WITH RETRACTABLE CORD” by Hewlett Packard. It is about 3 inches long (76 mm) and about 1.7 inches (43 mm) wide, so the aspect ratio is 1.77:1. Even the smallest prior art compact mouses are grasped with relatively extended fingers, wherein the distal phalanx (bone) of the first (index) finger is about 30 degrees from horizontal or about 120 degrees relative to the proximal phalanx thereof. This hand position is not a fully relaxed position.

Most users do not use compact mouses with desktop computers because they are less comfortable than full size mouses. They use compact mouses only when they have to, such as when traveling with a notebook computer. Also, prior art mini mouses typically have a generally horizontal top surface for being used by either hand, but such a horizontal top surface requires the forearm to twist almost 90 degrees from its natural position. The shapes of prior art compact mouses thus require the forearm and hand to be contorted to grasp them, thereby causing discomfort and even pain in many long term users.

Mouses are typically positioned on a side of the keyboard. Due to the width of a full sized keyboard, the user must move the mousing hand a long distance from the typing position to reach the mouse. Therefore, some users prefer to use the “ROLLERMOUSE” by Contour Design because the pointing device is arranged for positioning in front of the keyboard's spacebar, so that the hand movement from the typing position to the pointing device is significantly reduced. Since the pointing device is a roller bar which slides sideways but does not move forward and backward, the amount of space required is relatively small. However, the roller bar is far less intuitive to use than a conventional mouse.

There is no suggestion in the prior art for positioning a conventional mouse in front of a keyboard's spacebar. As small as they are, compact mouses are still too big to be positioned in front of a keyboard to replace the “ROLLERMOUSE”. Further, compact mouses typically have up to about 800 dpi resolution, so they must be moved a relatively long distance to move the pointer across the screen. Therefore, even when a compact mouse is positioned in front of the spacebar, the combination of the size and resolution requires a mousing area which is as deep as the keyboard itself. However, many desks do not have enough available space.

Even when a compact mouse is used in front of the keyboard, it would be held at a sharp angle away from facing forward. This is because the typing arms are angled towards each other, and when the arm is moved to grab the mouse, it is moved towards the user so the angle is increased even further away from the forward direction. A mouse with its front facing significantly away from a forward direction is difficult to use for accurately positioning the pointer on a screen.

### BRIEF SUMMARY OF THE INVENTION

Accordingly, the present compact ergonomic mouse is arranged to be even smaller than prior art compact mouses, yet provide greater comfort than any other compact mouse. It is arranged to reduce forearm twisting and the possibility of injury from long term use. It is also capable of being used in a relatively small space in front of the keyboard.

The present compact ergonomic mouse comprises a thumb side with a thumb engaging portion, a finger side with a finger engaging portion, a top with a button, a bottom, a front, and a rear. The distance between a distal end of the button and a rear of the thumb engaging portion is about 45-55 mm, which is just long enough to enable a last phalanx of the thumb of a relaxed hand to be generally centered on a rear half of the thumb side when a tip of a first finger is on the button and generally even with the distal end of the button, wherein the first finger is substantially curled with a distal phalanx thereof at an angle of about 80-100 degrees from a proximal phalanx thereof, so as to encourage relaxation of the hand.

### BRIEF DESCRIPTION OF THE SEVERAL VIEWS OF THE DRAWING

FIG. 1 is a left rear view of the present compact ergonomic mouse.

FIG. 2 is a right rear view.

FIG. 3 is a right side view.

FIG. 4 is a left side view.

FIG. 5 is a front view.

FIG. 6 is a rear view.

FIG. 7 is a top view.

FIG. 8 is a bottom view.

FIG. 9 is a sectional view taken along line 9-9 in FIG. 8.

FIG. 10 is a bottom view thereof with a tracking device rotated to a different radial direction.

FIG. 11 is a left rear view thereof grasped in a hand.

FIG. 12 is a left view thereof grasped in the hand.

### DETAILED DESCRIPTION OF THE INVENTION

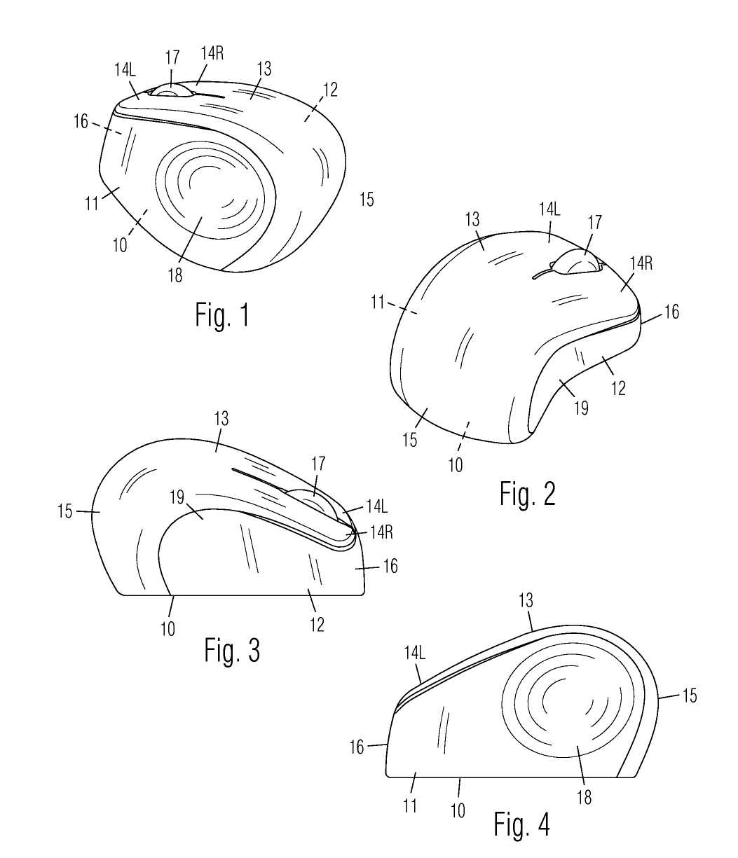

A right handed embodiment of a compact ergonomic mouse is shown in FIGS. 1-12. A left handed embodiment comprises a mirror image of the right handed embodiment.

In FIGS. 1-4, the mouse includes a bottom 10 for sliding on a horizontal surface, such as a desk or a mouse pad. A thumb side 11 and a finger side 12 are connected to opposite sides of bottom 10. A top 13 is connected between thumb side 11 and finger side 12. A front portion of top 13 is sloped upwardly from finger side 12 to thumb side 11. Top 13 includes buttons 14L and 14R at the front. In this example, top 13 includes two integrated buttons, but it may include more or fewer buttons, and the buttons may be discrete from top 13. Top 13 is also sloped downwardly from a rear 15 towards a front 16. A scroll wheel 17 is positioned on top 13. Alternatively, scroll wheel 17 may be replaced with another scrolling device or even eliminated.

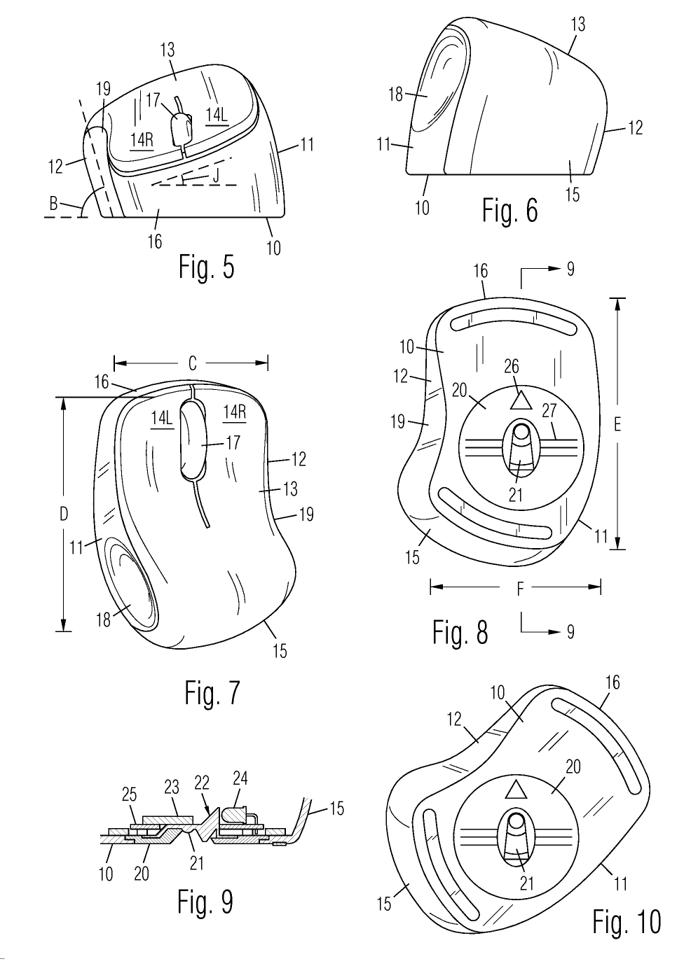

In FIGS. 5 and 6, thumb side 11 is angled vertically towards finger side 12, and finger side 12 is angled vertically away from thumb side 11, so that the mouse is generally tilted vertically when seen from the front or rear. As shown in FIG. 7, thumb side 11 is generally convex between front 16 and rear 15, and finger side 12 is generally concave. Thumb side 11 includes a thumb engaging portion 18 which is concave in this example, but thumb engaging portion 18 may be flat or convex. Most of thumb engaging portion 18 is on a rear half of thumb side 11 to minimize the length of the mouse. Finger side 12 includes a concave finger engaging portion 19. Finger side 12 is tilted at an angle B of about 80 degrees from horizontal. Angle B may range from about 60 degrees to about 85 degrees from horizontal.

In FIG. 7, the width C of the front of top 13, which in this example is the combined widths of buttons 14L and 14R, is about 1.30 inches (33 mm ) for supporting the first and second fingers. A distance D between the distal end of button 14L adjacent thumb side 11 and a rear of thumb engaging portion 18 is about 1.97 inches (50 mm). Concave finger engaging portion 19 of finger side 12 is more forward than a center of thumb engaging portion 18 since the third finger is longer than the thumb. Thumb engaging portion 18 is angled towards finger side 12 since a relaxed thumb is positioned inward and under the first finger.

In FIG. 8, bottom 10 has a length E of about 2.16 inches (55 mm) and a width F of about 1.54 inches (39 mm), so the aspect ratio is about 1.41:1. The length may vary from about 1.77 inches (45 mm) to about 2.17 inches (55 mm), and the width may vary from about 1.14 inches (29 mm) to about 1.93 inches (49 mm). A rotatable member 20 is positioned in bottom 10, and a tracking device 21 is entirely fixedly attached to rotatable member 20. In the example shown in FIG. 9 of a cross section of FIG. 8, tracking device 21 comprises an optical tracking device 22 well known in the art, which comprises an optical movement sensor 23 and a light source 24 mounted on a circuit board 25. In FIG. 8, an arrow symbol 26 on a bottom of rotatable member 20 is arranged to indicate a forward direction relative to tracking device 21. Knurls 27 on the bottom of rotatable member 20 provide an improved grip when turning rotatable member 20. Alternatively, tracking device 21 may comprise any other suitable type of tracking device.

Since tracking device 21 is entirely attached to rotatable member 20, tracking device 21 is completely rotated when rotatable member 20 is rotated. When a user holds the mouse with an arm angled away from a forward direction, such as when mouse is directly in front of a keyboard adjacent the spacebar, so that the front of the mouse is angled towards the other arm, rotatable member 20 may be rotated to reorient tracking device 21 with the forward direction, as shown in FIG. 10. Alternatively, rotatable member 20 may be eliminated and tracking device 21 directly attached to bottom 10.

In this example, tracking device 21 has a resolution of at least about 1600 dpi for more quickly moving the pointer with less hand movement. Therefore, the small size of mouse in combination with the relatively high resolution allows the mouse to be used in a relatively small space, such as directly in front of a desktop keyboard adjacent the spacebar, or even on top of a portable computer.

A relaxed hand resting on a desk tends to angle up from the ulnar side to the thumb side, so that the tip of the first finger is substantially higher than the tip of the second finger. As shown in FIG. 5, the front of top 13 is angled up from finger side 12 to thumb side 11 at an angle J of about 19 degrees from horizontal to reduce arm twisting and improve comfort. Angle J may range from about 10 degrees to about 25 degrees.

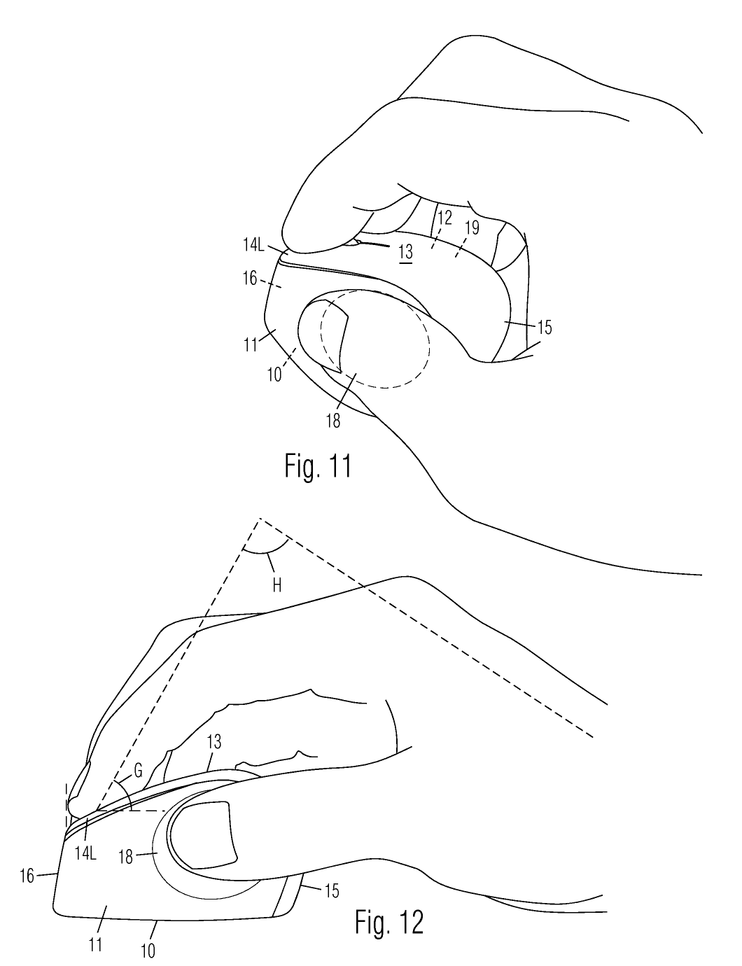

The fingers of a relaxed hand are curled with the fingertips pointing in directions generally perpendicular to the palm. Therefore the mouse is sized and shaped to substantially fit relaxed fingers for greater comfort, as shown in FIGS. 11 and 12. The mouse does not have any excess length beyond what is necessary to fit a relaxed hand, so that it is smaller than prior art compact mouses and can be used in a smaller mousing area.

In FIGS. 11 and 12, the tip of the thumb is against concave thumb engaging portion 18, the tips of the first and second fingers are on the front portion of top 13, and the inside of the last phalange of the third finger is against concave finger engaging portion 19 of finger side 12. Thumb side 11 and finger side 12 are short enough such that when the tips of the first and second fingers of a medium sized male hand are on top 13 and generally even with front 16, a distal phalanx of the thumb is generally centered on a rear half of thumb side 11, and a distal phalanx of the third finger is generally centered in finger engaging portion 19, the first finger is substantially curled with a distal phalanx thereof at an angle G of about 60 degrees from horizontal, and an angle H of about 90 degrees from a proximal phalanx thereof. A medium sized male hand is about 7.48 inches (190 mm) long from the tip of the middle finger to the wrist. Angle G may range from about 50 degrees to about 70 degrees, and angle H may range from about 80 degrees to about 100 degrees.

Although the foregoing description is specific, it should not be considered as a limitation on the scope of the invention, but only as an example of the preferred embodiment. Many variations are possible within the teachings of the invention. Therefore, the scope of the invention should be determined by the appended claims and their legal equivalents, not by the examples given.

I claim:

1. A computer mouse for sliding movement on a supporting surface, comprising:
a thumb side with a thumb engaging portion for engaging a thumb;
a finger side with a finger engaging portion for engaging a third finger;
a front between the thumb side and the finger side; and
a top with a front portion sloping upwardly from the finger side to the thumb side at about 10-25 degrees;
a button on the front portion of the top adjacent the thumb side; wherein
a distance between a distal end of the button and a rear of the thumb engaging portion is about 45-55 mm, which is just long enough to enable a last phalanx of the thumb of a relaxed hand to be generally centered on a rear half of the thumb side when a first finger is on the button and generally even with the distal end of the button, wherein the hand is about 190 mm from a tip of a middle finger to a wrist.

2. The computer mouse of claim 1, wherein the thumb engaging portion is generally tilted vertically towards the finger side when viewed from the front, and angled towards the finger side when viewed from the top; and the finger engaging portion is generally tilted vertically away from the thumb side when viewed from the front.

3. The computer mouse of claim 1, wherein the finger engaging portion is concave when viewed from the top, and tilted at about 60 to 85 degrees from horizontal when viewed from the front.

4. The computer mouse of claim 1, further including a movement sensor with at least about 1600 dpi resolution for moving a pointer quickly enough to enable the mouse to be used in a relatively small space.

5. The computer mouse of claim 1, further including:
a bottom between the thumb side and the finger side;
a rotatable member in the bottom; and
a tracking device entirely attached to the rotatable member so that the tracking device is entirely rotated when the rotatable member is rotated, wherein the rotatable member is rotatable to align the tracking device with a forward direction relative to a user when the front is angled away from the forward direction.

6. A computer mouse for sliding movement on a supporting surface, comprising:
a thumb side with a thumb engaging portion for engaging a thumb;
a finger side with a finger engaging portion for engaging a third finger;
a front between the thumb side and the finger side;
a top with a front portion sloping upwardly from the finger side to the thumb side at about 10-25 degrees; and
a button at the front portion of the top adjacent the thumb side; wherein
the thumb side and the finger side are sized such that when the tip of a first finger of a hand is on the top and generally even with a distal end of the button, and a distal phalanx of the thumb is generally centered on a rear half of the thumb side, the first finger is substantially curled with a distal phalanx thereof at an angle of about 80-100 degrees from a proximal phalanx thereof, wherein the hand is about 190 mm long from a tip of a middle finger to a wrist.

7. The computer mouse of claim 6, wherein the thumb engaging portion is generally tilted vertically towards the finger side when viewed from the front, and angled towards the finger side when viewed from the top; and the finger engaging portion is generally tilted vertically away from the thumb side when viewed from the front.

8. The computer mouse of claim 6, wherein a distance between the distal end of the button and a rear of the thumb engaging portion is about 45-55 mm.

9. The computer mouse of claim 6, further including a movement sensor with at least about 1600 dpi resolution for moving a pointer quickly enough to enable the mouse to be used in a relatively small space.

10. The computer mouse of claim 6, further including:
a bottom between the thumb side and the finger side;
a rotatable member in the bottom; and
a tracking device entirely attached to the rotatable member so that the tracking device is entirely rotated when the rotatable member is rotated, wherein the rotatable member is rotatable to align the tracking device with a forward direction relative to a user when the front is angled away from the forward direction.

11. A computer mouse for sliding movement on a supporting surface, comprising:
a thumb side for engaging a thumb;
a finger side for engaging a finger;
a top between the thumb side and the finger side;
a front between the thumb side and the finger side;
a bottom between the thumb side and the finger side;
a rotatable member in the bottom; and
a tracking device entirely attached to the rotatable member so that the tracking device is entirely rotated when the rotatable member is rotated, wherein the rotatable member is rotatable to align the tracking device with a forward direction relative to a user when the front is angled away from the forward direction.

12. The computer mouse of claim 11, wherein the tracking device comprises a circuit board attached to the rotatable member, an optical movement sensor attached the circuit board, and a light source attached to the circuit board.

13. The computer mouse of claim 11, wherein tracking device has a resolution of at least 1600 dpi.

14. The computer mouse of claim 11, further including a mark on the rotatable member to indicate a forward direction relative to the tracking device.
